(19) United States
(12) Patent Application Publication
(10) Pub. No.: US 2015/0350565 A1
(43) Pub. Date: Dec. 3, 2015

(54) TECHNIQUES FOR MAGNIFYING A HIGH RESOLUTION IMAGE

(71) Applicant: OpenTV, Inc., San Francisco, CA (US)

(72) Inventor: Sebastian Rapport, Grass Valley, CA (US)

(21) Appl. No.: 14/290,593

(22) Filed: May 29, 2014

(51) Int. Cl. H04N 5/262; H04N 19/85; H04N 5/265; H04N 19/44

(52) U.S. Cl. CPC H04N 5/2628; H04N 19/44; H04N 19/85; H04N 5/265

(57) ABSTRACT

Disclosed techniques can be used to provide a video magnification function whereby a user is able to selectively zoom in on a certain region of the displayed video and be able to view content detail that is otherwise lost during the downsampling process. Some configurations may use two different decoders, a first decoder that decompresses and downsamples an entire image and a second decoder that downsamples only a select portion under the magnifier window. The results of the two decoders are combined to produce a final video for display on the screen.

### BACKGROUND

This document relates to presentation of video on a user interface.

Advances in video technologies have recently led to the introduction of video transmission and display formats that have higher resolutions than ever before. In comparison with video transmission formats in which each video picture has 720×480 resolution (“standard definition” or SD) or 1280×720 (“high definition” or HD) or 1920×1080 (“full HD”), new formats allow encoding and transmission of up to 4096×4096 or 8192×8192 (“ultra-high definition” or UltraHD) transmission formats. Many currently deployed display technologies cannot reproduce video at the ultra-high definition resolution and usually incorporate a downsampling technology in which video resolution is reduced for displaying.

### SUMMARY

Techniques for enabling magnification of a high resolution image when being displayed on a lower resolution display are disclosed.

In one aspect, a method for providing selectively magnified video content is disclosed. The method includes receiving encoded video content comprising a plurality of images encoded at a first resolution, operating a first decoder to produce a primary decoded video content from the encoded video content, the primary decoded video content having a second resolution that is less than the first resolution, receiving a first zoom command at a user interface, determining, selectively based on an operational status, a magnifier region and a third resolution for satisfying the first zoom command, operating, responsive to the determination, a second decoder to generate a secondary decoded video content in a window corresponding to the magnifier region at the third resolution, and combining the primary decoded video content and the secondary decoded video content to produce an output video image.

In another aspect, an apparatus for magnified video display is disclosed. The apparatus includes a first video decompressor that decompresses a video bitstream having a full resolution, a first transcoder that downsamples the decompressed video bitstream to produce a first video having a first resolution that is less than the full resolution, a user interface controller that receives a user command, a magnification module that, responsive to the received user command, determines a region of video to zoom in on and a zoom-in factor, a second transcoder that downsamples the decompressed video bitstream to a second video having a second resolution, the second resolution being at most equal to the full resolution and greater than the first resolution; wherein the second resolution depends on the zoom-in factor, and a video combiner that combines the first video and the second video to produce a display output.

In yet another aspect, a video display system includes a primary display and a secondary display, both displays having different display resolutions. The primary and secondary devices may each have a communication interface over which the primary and secondary devices may communicate data and control traffic. The data traffic may include display information in the form of compressed or uncompressed video. The control traffic may include control data indicative of video control gestures received at a user interface of the secondary display. A first video decoder displays video at a first resolution on the primary display by downsampling native resolution of video content. A second video decoder is operated responsive to a control gesture so that a level of detail of content presented in a magnifier region is greater than that presented by the first video decoder.

These, and other, aspects are described below in the drawings, the description and the claims.

### BRIEF DESCRIPTION OF THE DRAWINGS

FIG. 1A depicts an example video delivery system.

FIG. 1B depicts another example video delivery system.

FIG. 2 depicts an example display screen.

FIG. 3 depicts an example display screen.

FIG. 4 depicts an example display screen.

FIG. 5 depicts an example display screen.

FIG. 6 is an example video display system with a primary display and a secondary display communicatively coupled to the primary display.

FIG. 7 is a flowchart of an example method for providing video content zooming on a user interface.

FIG. 8 is an apparatus for displaying video to a user.

Like reference symbols in the various drawings indicate like elements.

### DETAILED DESCRIPTION

In various display applications, a high resolution video or image may be converted to a lower resolution video or image for display to match the display resolution capability of a display device. For example, new UltraHD broadcasts (typically 4K or 8K resolution, corresponding to 4096×4096 or 8192×8192 pixel picture dimensions) provide greater resolution than can be displayed on lower resolution display devices, such as second screen devices or smaller televisions. Due to the limitation in native display resolution of these devices, the high resolution video or images in UltraHD broadcasts are reduced by down sampling to fit the lower native resolution of the devices. Therefore, some visual detail may get lost in this downsampling.

In broadcasting sporting events such as a soccer game, the videos of goals and disputed plays can be zoomed in and analyzed by the broadcaster or others to provide more details on a particular action or event during the game. There are also times when individuals or groups of people may want to examine a particular event or play, but the video or image quality in various existing display systems tends to be limited to reviewing the original displayed video, or as recorded on a video recorder such as a digital video recorder (DVR) or a personal video recorder (PVR).

The disclosed technology can be implemented to mitigate the above undesired technical issues due to downsampling so that visual detail that was originally received in a high resolution video at a first resolution, which may be lost and unviewable due to downsampling or transcoding to match the lower resolution of a display at a second resolution lower than the first resolution, may be presented to a user. The disclosed technology can be used to increase the apparent resolution of a display by zooming in or magnifying visual detail that may otherwise be filtered out or be too small for a human to discern. As a result, the apparent resolution of the display at the second resolution is increased to a third resolution higher than the second resolution.

In some embodiments, an on-screen magnifier is provided as a part of user control functions to enable users to select and zoom into a portion of a high resolution video at the first resolution to get a clear look at detail that is not rendered on smaller screens at a lower second resolution. This on-screen magnifier can be selectively activated and deactivated via user control. The magnifier can zoom in or out and panned around the frame to examine details with simple gestures via a second screen at a third resolution higher than the second resolution and be mirrored on a first screen. The user can rewind, fast-forward, or slow play while magnifier is active with gestures on second screen. The magnifier may be configured to provide a rectangular or circular magnification zone or region at the third resolution within a video on the screen and the magnified zone or region may have a suitable or desired size relative to the screen on which it is being displayed. In some embodiments, a second screen may not be present, and a remote control may be used to control the magnifier. The third resolution may be different from the first resolution at which the video content is received. These, and other, aspects are disclosed in the present document.

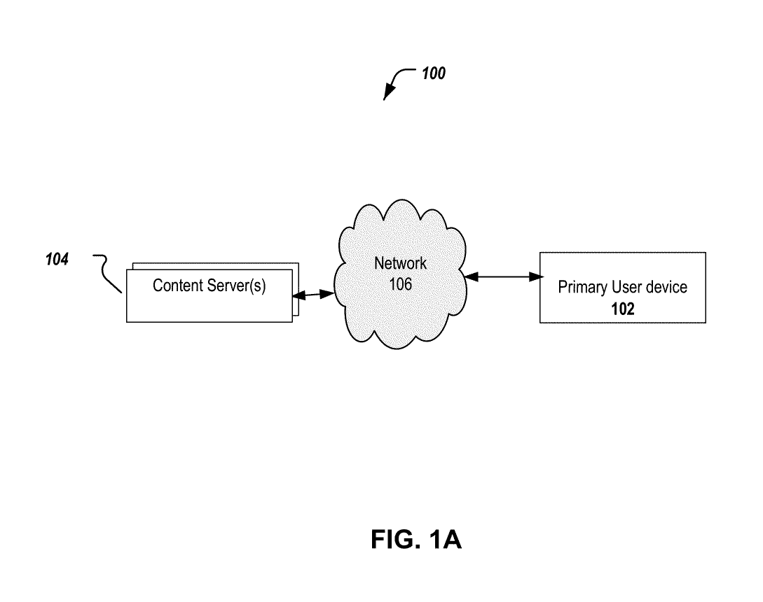

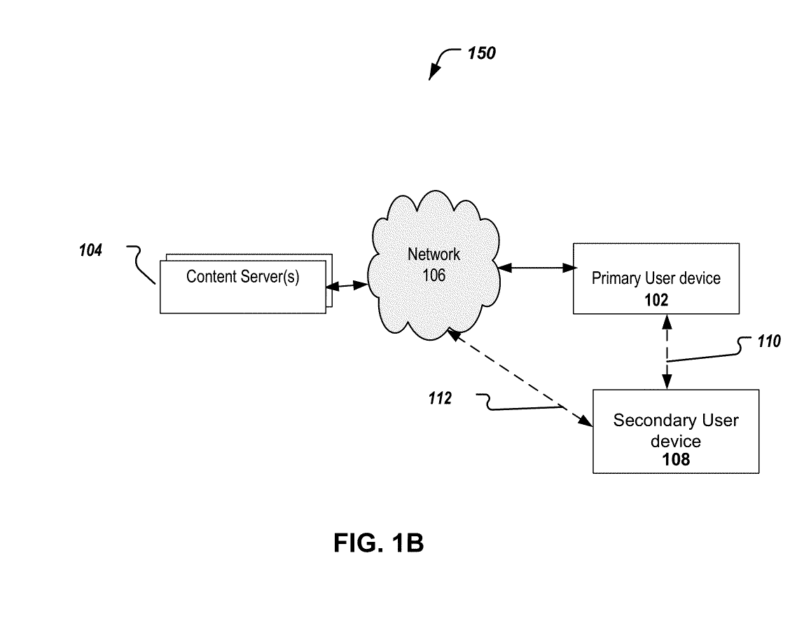

FIG. 1A depicts an example system configuration 100 in which a primary user device 102 receives content from a content server 104 via a communication network 106. The primary user device 102 may, e.g., be in a user premise and may be a set-top box, a digital television, an over-the-top receiver, and so on. The content server 104 may represent a conventional program delivery network such as a cable or a satellite headend or may represent a, internet protocol (IP) content provider's server. The communication network 106 may be a digital cable network, a satellite network, a digital subscriber line (DSL) network, wired and wireless Internet and so on. The primary user device 102 may have a display built in (e.g., a digital television) or may represent multiple hardware platforms, as further described in the present document, the primary user device may represent different functions performed (e.g., signal reception, signal decoding, signal display, etc.).

FIG. 1B represents a communication configuration 150 that, in addition to the communication configuration 150, includes a secondary user device 108. In some embodiments, communication channels 110 and 112 may be present. The channel 110 may represent, e.g., a peer-to-peer connection between the primary and secondary user devices. Some non-limiting examples of the channel 110 include a wireless infrared communication link, a Bluetooth link, a peer-to-peer Wi-Fi link, AirPlay connectivity by Apple, Miracast, wireless USB (universal serial bus), wireless HDMI (high definition media interface), and so on.

In some embodiments, the secondary user device 108 may be a companion device such as a tablet or a smartphone and may be used to display the same video that is being displayed on the primary user device 102, or a display attached to the primary user device. The secondary user device 108 may also be able to communicate with the network 106 and the content server 104, as further discussed below. In some embodiments, the secondary user device 108 may, alternatively or additionally, provide a control interface to the user by which the user can control the operation of the primary user device 102.

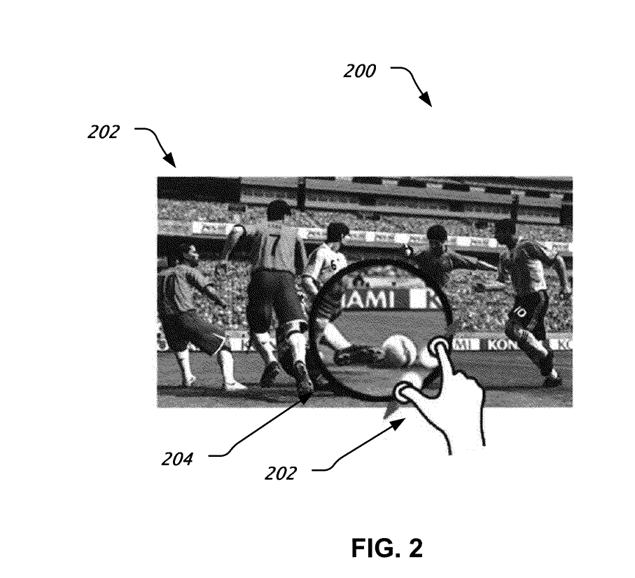

FIG. 2 depicts an example 200 of a user interaction received on a user interface 202. The user interface 202 may be on the primary user device 102, on a display attached to the primary user device 102 or at the secondary user device 108. The user interface 202 may be displaying a video content, e.g., a soccer (football) game, as depicted in FIG. 2. While displaying the video, the user interface 202 may receive a gesture, e.g., two-finger gestures 206, on the user interface 202 to provide the user control for activating and perform on-screen magnifier functions. The gesture 206 may include the user touching the user interface 202 at two contact points and dragging the contact points away from each other, thereby indicating approximately the picture area at which the magnification or the zoom-in should occur.

The gesture 206 may result in zooming in (e.g., when finger contacts move away from each other) or out (e.g., when finger contacts move closer to each other) of an area, called magnifier 204, on the display screen. As one design option, moving fingers away from each other may zoom into video at that location. Moving fingers towards each other may reduce the zoom level and may close the magnifier 204 entirely. In some embodiments, when magnifier 204 is active, the content outside the region of the magnifier 204 may be displayed in a different display mode than the region of the magnifier 204 to enable the magnifier 204 to visually stand out, e.g., the display areas outside the region of the magnifier 204 can be in, a reduced display brightness or contrast, or, as shown in FIG. 2, in black and white display mode (or more generally, in a luma-only mode) to make the zoomed content a focal point.

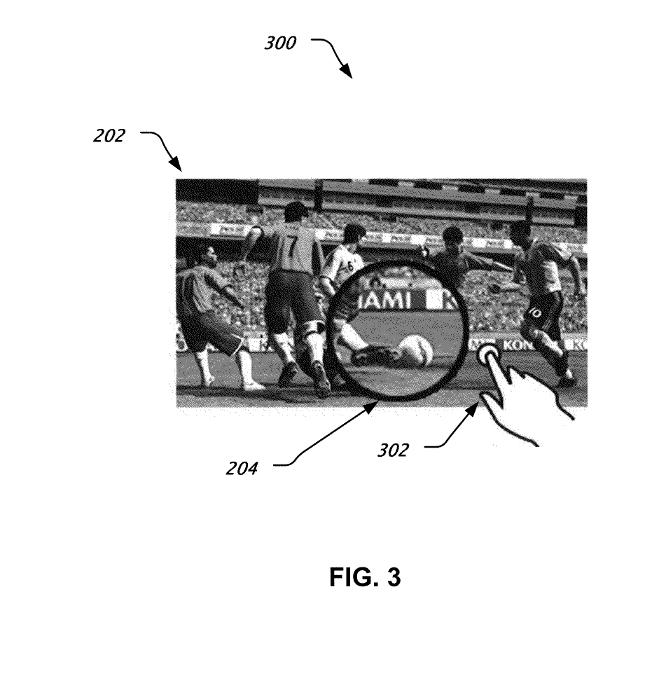

FIG. 3 depicts an example 300 in which a tap-gesture 302 may be received at the user interface 202 to control the playing of the video within the magnifier 204. A tap-gesture 302 may include a user making a contact at a point on the display screen. Alternatively, tap-gesture 302 may include two or three successive touches at a same location on the display screen, e.g. made within one second of each other. In some embodiments, a tap-gesture may be used to toggle between playing and pausing video. The tap gesture may selectively play or pause video

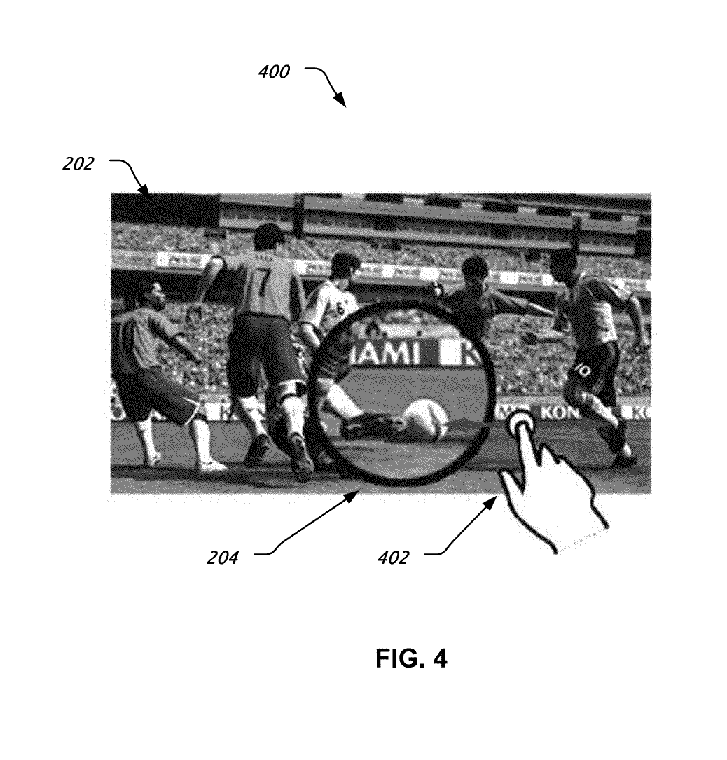

FIG. 4 depicts an example 400 in which the control-gesture 402 is provided to change the play speed of video displayed on the user interface 202. For example, holding and dragging transitions to play back speed control gesture may be performed via speed control gesture 402. Dragging a finger to the right, while in contact with the display screen, may play the video in the forward direction. In some embodiments, the speed of finger drag, the length of the finger drag, etc. may control or adjust the playback speed (e.g., at 2× speed or at 4× speed, etc.). Similarly, dragging the finger to the left may similarly result in video playback in the reverse direction and 2× or 4× or another rewind speed.

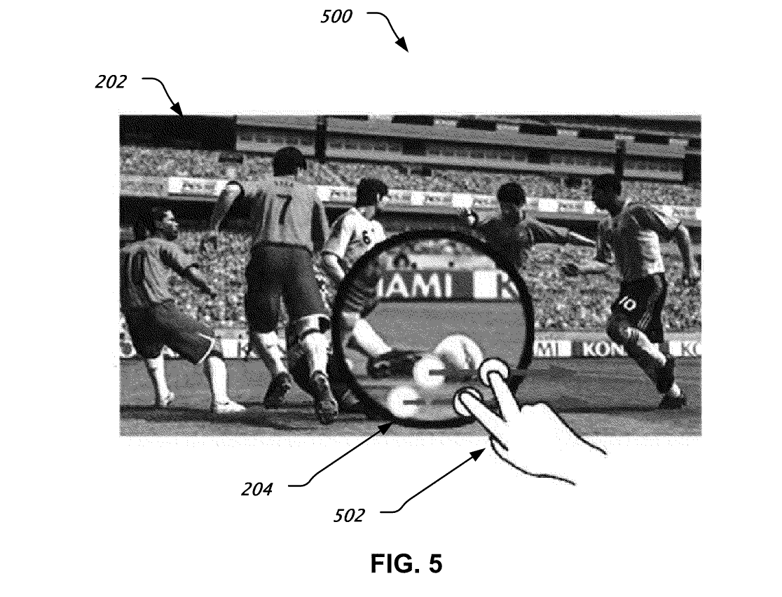

FIG. 5 depicts an example 500 in which a two-finger gesture 502 is used to move the magnifier region 204 around the video display area. In some embodiments, a user may simultaneously contact the display screen at multiple locations, e.g., using two or three finger touches, and may perform a two-finger drag gesture to move the magnifier around the video frame.

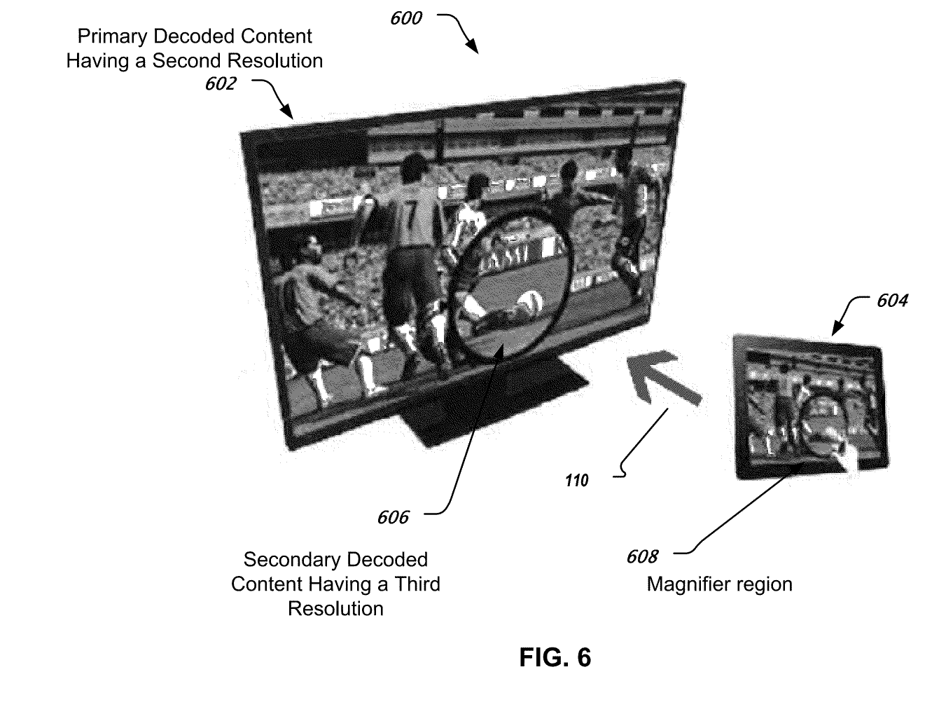

FIG. 6 depicts an example configuration 600 of a primary display 602 on which content received at a first resolution can be displayed at a second resolution (e.g., native resolution of the primary display 602) and a secondary display 604. The primary display 602 may be a part of the primary user device 102 or may be connected to the primary user device 102. The secondary display 604 may be a part of the secondary user device 108 or connected to the secondary user device 108. As illustrated, a user of the device 604 can use finger gestures to select a magnifier region 608 on the device 604 to be at a third resolution that provides a greater magnification than the second resolution of the device 604. In some embodiments, the primary display 602 may mirror, or duplicate, what is being controlled via the secondary display 604 and correspondingly display content in a magnifier region 606 at a third resolution, e.g., an apparent change in resolution due to magnification making greater detail visible in the region 606. This mode of operation may be useful in some multiuser circumstances when a user of a tablet device as the secondary display 604 wants to show certain details in a video to other people viewing the primary user device 102.

In some embodiments, content may be received or locally stored at the primary user device 102 as encoded compressed video stream (e.g., using a standards-based encoding scheme). The content may have a resolution that is greater than the resolution at which the content can be displayed on the primary user device 102. For illustrative example, assume that the received (or stored) content is encoded in a 4K format. Further, it is assumed that the primary user device 102 can display at the resolution of 1080P, which could be considered 1K format. In other words, content is available at a resolution of four times more pixels in the horizontal and vertical directions than can be displayed on the primary display device 102.

The primary user device 102 may include a primary video decoder. The primary video decoder may include a primary decompression module that decompresses compressed video bits into an uncompressed format. The uncompressed format video may at least temporarily be stored at the full resolution (e.g., the 4K resolution) so that reconstructed video can be used as a reference for future video decoding. The primary video decoder may also include a primary transcoding module that transcodes from the full resolution format to a lower display resolution (e.g., 1K resolution). In some embodiments, the decompression and temporary storage, or caching, of video at full resolution may be performed “internally” to the primary video decoder such that only display resolution video data may be made available externally and the full resolution data may be overwritten during video decoding process.

In some embodiments, the content detail information, that a transcoding operation may thus “throw away,” making it unrecoverable or unpresentable to the user, may be preserved by presenting via the magnifier region. In some embodiments, when a control gesture is received from a user to magnify a certain portion of the display area, the primary user device 102 may use a secondary decoder module to decode and present to the user content falling under the magnifier region at the desired resolution. For example, in one configuration, the primary decoder may be configured to decode incoming 4K video, transcode the video from 4K resolution to 1K resolution (e.g., by downsampling by a factor of 4 in both the horizontal and vertical directions), and present the 1K transcoded video to display. As an example, when a user command is received to magnify a certain portion by a factor of 2, the secondary transcoder module may be configured to transcode the magnifier region by downsampling by a factor of 2 (from 4K resolution to 2K resolution—which achieves the magnification factor of 2).

In some embodiments, a first software video decoder may be used for decoding and downsampling the primary video. A second software process may be used to downsample a portion of the decoding output of the first (primary) video decoder.

In some embodiments, a first hardware video decoder may be used for decoding and downsampling the primary video. A second hardware downsampling module may downsample full resolution video under the magnification region by a different downsampling factor, which is a smaller number than the downsampling factor used for the primary video, for presenting the magnifier output.

In some embodiments, outputs of the primary video decoder and the secondary video decoder may be combined to generate a final output that for displaying to the user interface or display screen on which the user desires to view the content. In some embodiments, the combination may be alpha blended. In some embodiments, the combination may be made such that in the magnifier region, only the output of the secondary video decoder may be shown on the display screen and in the remaining portion, only the primary video decoder output may be shown.

In some embodiments, the secondary video decoder may comprise a secondary video decompression module and a secondary video transcoding module. The secondary video decoder may be used to decode only content that falls under the magnifier region. A pixel map may be generated for the decoded image and then mixed in with the underlying image. A region by which to decode may be thus derived from the magnifier command. When transcoding from 4K to a smaller resolution, the decoding may be performed separately for the primary screen, at its resolution, and for second screen, at an increased resolution. In some embodiments, the decoding may be MPEG based and the decoding may be made aware of the magnifier region. The decoding may be performed in a layered or a sequential operation. For example, the secondary screen maybe 1024×960, the input image may be at 4K resolution. The transcoder function in MPEG decoder may downsample during decoding to the 1024 resolution. But in the area where zooming in is used, another decode process may be created which takes a smaller rectangle in the 4K image and that would be content that normally would be lost. One buffer stores the screen in one detail level, another decoder decodes screen

In some embodiments, the communication link 110 may carry uncompressed video, e.g., bitmap for display. For example, HDMI (high definition multimedia interface) format may be used to carry display information from the primary user device to the secondary user device. For example, if video with 4K resolution is being sent across HDMI, then the primary device may be performing both the primary video and magnifier decoding and simply sending display images or screen shots to the secondary user device.

As a variation, a control message may be exchanged over the link 110, informing the primary user device about “give me this portion of the video at this resolution” from the secondary user device to the primary device. The video portion may be specified in terms of X-Y coordinates of a rectangular window, or center location and radius of a circular window, etc. The resolution may be specified as a zoom-in or a magnification factor, based on user control received. Access to the magnified content may be controlled by the level of entitlement of the primary device, the secondary device, etc. For example, in some embodiments, a user may be allowed to magnify content and may be charged on a per-transaction or a per-program basis. Alternatively or additionally, a content provider (e.g., an entity that controls the operation of the content server 104) may provide access to magnifiable content via a business arrangement with a service provider (e.g., a network service provider for the network 106).

Video compression technique such as scalable video encoding (e.g., SVC profile of the H.264 video compression standard) may be another way to bring in multi-resolution images into a decoder. A way to enable to magnification or additional rich content (e.g., infrared)

In some embodiments, a single-finger drag gesture may be used to control playback direction (forward/reverse) and speed. In some embodiments, dragging a finger to left may play video backwards while dragging a finger to right may play video forward. The farther a finger is dragged from the initial touch point, the faster the rate at which the video is played in a given direction. In some embodiments, tapping the screen may toggle between play and pause. When finger is released, play may stop. In some embodiments, gesture behavior may be user-selectable via a preferences menu.

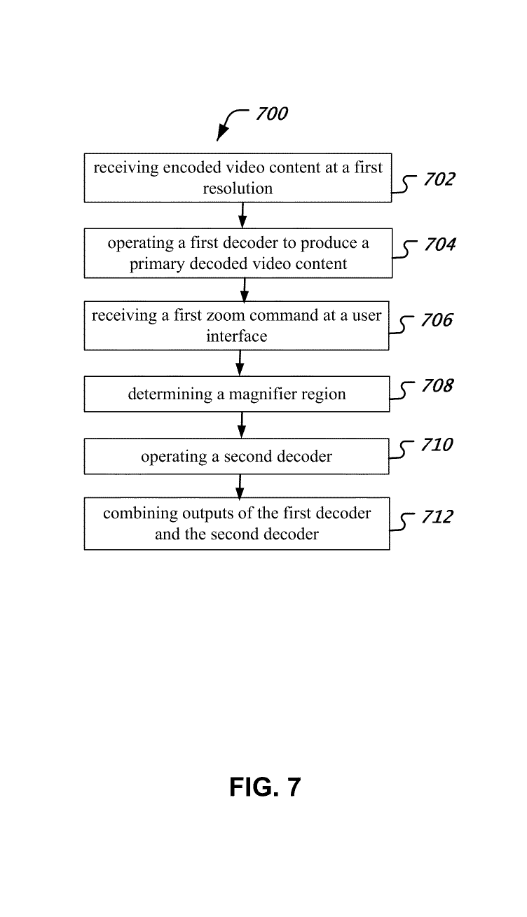

FIG. 7 is a flowchart depiction of an example of a method 700 for displaying video on a display. The method 700 may be implemented by the primary user device 102 and/or the secondary user device 108.

At 702, encoded video content comprising a plurality of images encoded at a first resolution is received. For example, the content may be received via the network 106. Alternatively, the content may have been received and stored in a locally memory, e.g., a hard drive of a PVR (personal video recorder).

At 704, a first decoder is operated to produce a primary decoded video content from the encoded video content. The primary decoded video content has a second resolution that is less than the first resolution. For example, the received video content may have an ultra-HD resolution such as 4K or 8K and the primary decoded video content may be at HD resolution.

At 706, a first zoom command is received at a user interface. As disclosed, the user interface may be the display on which primary decoded video content is displayed or may be a remote control or a secondary user device. The zoom command may be received, e.g., as described with respect to FIG. 2.

At 708, selectively based on an operational status, a magnifier region and a third resolution for satisfying the first zoom command is determined. As described, e.g., with respect to FIG. 2, the geometry and dimensions of the magnifier region may be defined by the duration and span of the user's touch with the user interface. In some embodiments, the third resolution may, e.g., be used to provide a magnified view of content within the magnified region without changing the display resolution.

At 710, responsive to the determination, a second decoder is operated to generate a secondary decoded video content in a window corresponding to the magnifier region at the third resolution.

At 712, the primary decoded video content and the secondary decoded video content are combined to produce an output video image.

In some embodiments, the first decoder is operated to decompress the encoded video content to produce decompressed video content at the first resolution and transcode the decompressed video content at the first resolution to produce the primary decoded video content having the second resolution. The second decoder may transcoding the decompressed video content at the first resolution to produce the primary decoded video content having the second resolution.

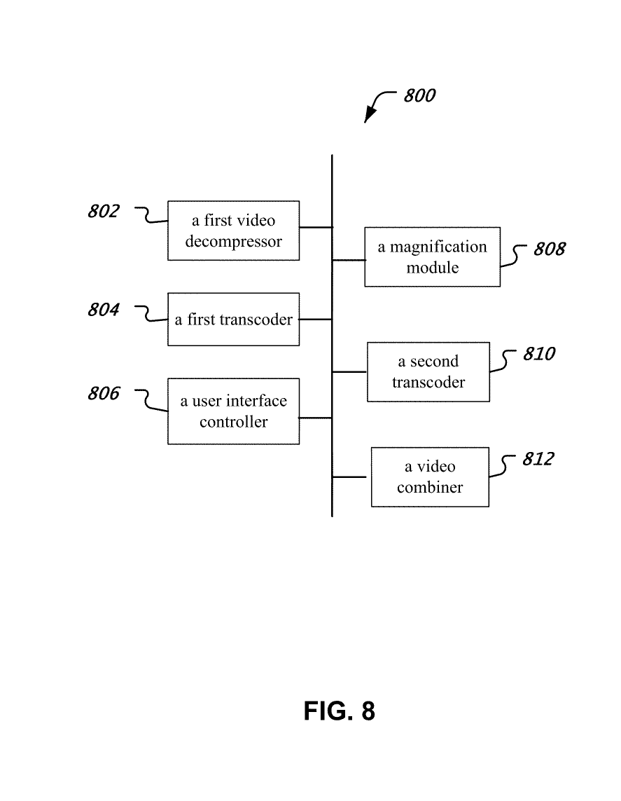

FIG. 8 depicts an example of an apparatus 800 for displaying video to a user interface. A first video decompressor 802 decompresses a video bitstream having a full resolution. A first transcoder 804 downsamples the decompressed video bitstream to produce a first video having a first resolution that is less than the full resolution. A user interface controller 806 receives a user command. A magnification module 808 determines, responsive to the received user command, a region of video to zoom in on and a zoom-in factor. A second transcoder 810 downsamples the decompressed video bitstream to a second video having a second resolution. The second resolution is at most equal to the full resolution and greater than the first resolution, and the second resolution depends on the zoom-in factor. The video combiner 812 combines the first video and the second video to produce a display output.

In some embodiments, the magnification module determines the zoom-in factor based on a dimension of a contact motion received from the user interface. In some embodiments, the user interface controller further receives a pause command and, in response, causes the display output to pause. In some embodiments, the video combiner combines the first video and the second video such that only the second video is displayed inside a magnifier region and only the first video is displayed outside the magnifier region. In some embodiments, alternatively or additionally, the video combiner combines the first video and the second video such that only luminance portion of the first video is displayed outside the magnifier region. In some embodiments, the magnifier region has a non-rectangular shape and wherein the window corresponds to a rectangular shape that includes the magnifier region. In some embodiments, the user interface controller further receives a trick mode gesture, in response, causes the display output to be displayed in the trick mode.

In some embodiments, a system of displaying video content includes a primary display and a secondary display. The primary display may be a part of or attached to the primary user device 102. The secondary display may be a part of, or attached to, the secondary user device 108. The secondary display is communicatively coupled to the primary display via a communication link, e.g., link 110. The primary display and the secondary display may communicate with each other via the communication link 110. The communication may include data (e.g., video bitmap, compressed video, program guide, etc.) and/or control data communication. For example, the data traffic from the primary display to the secondary display may include video data that corresponds to what is being displayed on the primary display. The control traffic from the secondary display to the primary display may include control data that instructs a video decoder at the primary display to decode video within a magnification window at a certain magnification factor. In some embodiments, a first video decoder at the primary display may decode video for display in the entire display area, and a second video decoder may generate video at a different magnification factor in the magnification region. A combiner may combine the two videos such that in the magnification region, the second video replaces (or non-transparently overlays) the first video.

In some embodiments, the previously described trick mode control (pause, rewind, fast forward) etc. may be achieved by receiving a haptic feedback (e.g., as described in FIG. 2, FIG. 3, FIG. 4 or FIG. 5) and generating control messages to control the operation of the first and the second video decoders.

It will be appreciated that several techniques have been described to enable a user's viewing of video detail that would otherwise be lost due to downsampling or transcoding performed to match the lower resolution of a display.

It will further be appreciated that using the disclosed techniques, a user is able to use haptic controls such as pinch, finger drag, tap, etc. to control magnification of a less-than-all region of a display on which live video is being displayed, to achieve pause, rewind, fast forward, etc.

The disclosed and other embodiments, the functional operations and modules described in this document (e.g., a content receiver module, a storage module, a bitstream analysis module, a credit determination module, a playback control module, a credit exchange module, etc.) can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

As a specific example, an example processing code is included below to illustrate one implementation of the above disclosed processing.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method of providing selectively magnified video content, comprising:
receiving encoded video content comprising a plurality of images encoded at a first resolution;
operating a first decoder to produce a primary decoded video content from the encoded video content, the primary decoded video content having a second resolution that is less than the first resolution;
receiving a first zoom command at a user interface;
determining, selectively based on an operational status, a magnifier region and a third resolution for satisfying the first zoom command;
operating, responsive to the determination, a second decoder to generate a secondary decoded video content in a window corresponding to the magnifier region at the third resolution; and
combining the primary decoded video content and the secondary decoded video content to produce an output video image.

2. The method of claim 1, wherein the operating the first decoder includes;
decompressing the encoded video content to produce decompressed video content at the first resolution; and
transcoding the decompressed video content at the first resolution to produce the primary decoded video content having the second resolution.

3. The method of claim 2, wherein the operating the second decoder includes:
transcoding the decompressed video content at the first resolution to produce the secondary decoded video at the third resolution.

4. The method of claim 1, further including:
receiving a second zoom command at the user interface;
determining, by comparing with the first zoom command, whether the second zoom command results in a change to the third resolution; and
changing a downsampling parameter of the second decoder to cause the change to the third resolution.

5. The method of claim 1, further including:
receiving a pause command at the user interface; and
selectively, responsive to a location at which the pause command is received at the user interface, pausing display of one of the primary decoded video content and the secondary decoded video content.

6. The method of claim 1, wherein the combining includes:
displaying only the secondary decoded video content inside the magnifier region; and
displaying only the primary decoded video content outside the magnifier region.

7. The method of claim 6, wherein the displaying only the primary decoded video content outside the magnifier region includes displaying only luminance portion of the primary decoded video content outside the magnifier region.

8. The method of claim 1, wherein a first downsampling factor for generation of the primary decoded video content is greater than a second downsampling factor for generation of the secondary decoded video content.

9. The method of claim 1, wherein the magnifier region has a non-rectangular shape and wherein the window corresponds to a rectangular shape that includes the magnifier region.

10. The method of claim 1, wherein the operational status comprises a user authorization to access zoomed or magnified content.

11. An apparatus for magnified video display, comprising:
a first video decompressor that decompresses a video bitstream having a full resolution;
a first transcoder that downsamples the decompressed video bitstream to produce a first video having a first resolution that is less than the full resolution;
a user interface controller that receives a user command;
a magnification module that, responsive to the received user command, determines a region of video to zoom in on and a zoom-in factor;
a second transcoder that downsamples the decompressed video bitstream to a second video having a second resolution, the second resolution being at most equal to the full resolution and greater than the first resolution; wherein the second resolution depends on the zoom-in factor; and
a video combiner that combines the first video and the second video to produce a display output.

12. The apparatus of claim 11, wherein the magnification module determines the zoom-in factor based on a dimension of a contact motion received from the user interface.

13. The apparatus of claim 11, wherein the user interface controller further receives a pause command and, in response, causes the display output to pause.

14. The apparatus of claim 11, wherein the video combiner combines the first video and the second video such that only the second video is displayed inside a magnifier region and only the first video is displayed outside the magnifier region.

15. The apparatus of claim 14, wherein the video combiner combines the first video and the second video such that only luminance portion of the first video is displayed outside the magnifier region.

16. The apparatus of claim 11, wherein the magnifier region has a non-rectangular shape and wherein the window corresponds to a rectangular shape that includes the magnifier region.

17. The apparatus of claim 11, wherein the user interface controller further receives a trick mode gesture, in response, causes the display output to be displayed in the trick mode.

18. A system of displaying video content, comprising:
a primary display; and
a secondary display that is communicatively coupled to the primary display via a communication link;
wherein the primary display and secondary display communicate data and control traffic via the communication link;
wherein data traffic from the primary display to the secondary display includes video data;
wherein control traffic from the secondary display to the primary display includes control data indicative of a magnification factor and a magnification region;
the system further comprising:
a first video decoder that operates to generate video for display on the primary display;
and.
a second video decoder that, responsive to the magnification factor and the magnification region, operates to generate video for display in the magnification region; and
a combiner that combines video outputs of the first video decoder and the second video decoder.

19. The system of claim 18, wherein the control traffic further includes control data indicative of a trick mode for video, and wherein the first video decoder and the second video decoder generate video responsive to the trick mode control data.

20. The system of claim 18, wherein the secondary display generates the magnification factor and the magnification region based on a haptic signal received by the secondary display.
